(19) United States
(12) Patent Application Publication
(10) Pub. No.: US 2017/0178231 A1
(43) Pub. Date: Jun. 22, 2017

(54) WEARABLE TRADING DEVICE

(71) Applicant: TRADING TECHNOLOGIES INTERNATIONAL INC., CHICAGO, IL (US)

(72) Inventor: Patrick J. ROONEY, St. Charles, IL (US)

(21) Appl. No.: 14/975,402

(22) Filed: Dec. 18, 2015

(51) Int. Cl. G06Q 40/04

(52) U.S. Cl. CPC G06Q 40/04

(57) ABSTRACT

A wearable trading device may be implemented to indicate a market position of a tradeable object at an electronic exchange. The wearable trading device may include market indicators that may be activated to identify relative changes in the market position of the tradeable object. The market indicators may be activated differently to identify different types of market data, such a price data and/or quantity data for different types of orders. Changes in the market data may be indicated relative to a reference point, such as a centering price of the tradeable object. The centering price of the tradeable object may be a last traded price of the tradeable object. The wearable trading device may detect relative changes in the market and accordingly update the market indicators to reflect the detected changes. The wearable trading device may be implemented to execute trade orders at an electronic exchange.

### BACKGROUND

An electronic trading system generally includes a trading device in communication with an electronic exchange. The trading device receives information about a market, such as prices and quantities, from the electronic exchange. The electronic exchange receives messages, such as messages related to orders, from the trading device. The electronic exchange attempts to match quantity of an order with quantity of one or more contra-side orders.

As orders are continuously being filled in the market, a user of the trading device may wish to track the market throughout the day. Current trading devices often include a work station with a display that allows the user to view the changes in the market. It may be difficult, however, for users to track the market during certain periods of the day, such as when the user gets called away to a meetings, is involved in a conversation, or is otherwise unable to monitor the display on the trading device.

While there is currently an effort to offer information about the market to users on mobile devices, such as cell phones and/or tablets, the user must remember to carry such devices with them on their person. Additionally, these mobile devices fail to provide the market information to the user in a discrete format that may allow the user to monitor the market while staying engaged and uninterrupted during other activities.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates a diagram representative of an example system in which certain embodiments may be employed.

FIGS. 5A-5D illustrate example configurations of wearable trading devices.

FIG. 6 illustrates a block diagram representative of an example system in which certain embodiments may be employed.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

Systems, methods, and apparatus are described herein for wearable trading devices that indicate a market position of a tradeable object at an electronic exchange. For example, the wearable trading device may be a wristband or a watch. The wearable trading device may include market indicators, such as light modules, haptic communication modules, and/or temperature modules, that may be activated to identify the relative changes in the market position of the tradeable object at the electronic exchange. The market indicators may be activated differently to identify different types of market data, such as price data and/or quantity data for different types of orders for example.

The market indicators may be located around the circumference of the wristband, such as on the inside or outside of the wristband for example. The market indicators may be spaced around the circumference of the wristband at relatively different distances from the center of the wristband to identify different relative changes in market data upon activation.

Changes in the market data may be indicated relative to a reference point, such as a centering price of the tradeable object. The centering price of the tradeable object may be a last traded price of the tradeable object at a time at which the tradeable object is stored at the wearable trading device. The centering price may be represented on the wearable trading device at a point of reference, such as at the center of the wristband for example.

The wearable trading device may detect a relative change in the market data received from the electronic exchange and accordingly update the market indicators to reflect the detected changes. For example, the wearable trading device may detect a last traded price of the tradeable object, and activate at least one of the market indicators that reflects the relative change in the last traded price from the reference point on the wearable trading device.

The wearable trading device may include a display. The wearable trading device may receive market data and display the market data on the display. The market data may include a last traded price, an order quantity, a net change, an order type, an open profit/loss (P/L), an execution average price, and/or a net position.

The wearable trading device may be implemented to execute trade orders at an electronic exchange. The wearable trading device may receive an indication of an order price and/or an order quantity for a trade order to be submitted to the electronic exchange and may trigger the trade order to be submitted to the electronic exchange. The trade order may be submitted to the electronic exchange for a complete fill of a quantity of a tradeable object a user has pending at the electronic exchange. The trade order may be submitted to the electronic exchange directly from the wearable trading device or via another computing device.

The embodiments described herein may be implemented by a computing device, such as an electronic wristband or watch. For example, the electronic wristband or watch may comprise hardware and software modules for implementing the described embodiments.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. BRIEF DESCRIPTION OF CERTAIN EMBODIMENTS

Systems, methods, and apparatus are described herein for wearable trading devices that indicate a market position of a tradeable object at an electronic exchange. The wearable trading device may include market indicators configured to indicate relative changes in the market position of the tradeable object at the electronic exchange. The wearable trading device may receive an indication of a last traded price associated with the tradeable object, determine a relative change in the last traded price associated with the tradeable object, and identify at least one of the market indicators that reflects the relative change in the last traded price associated with the tradeable object. The wearable trading device may indicate, via the at least one market indicator, the relative change in the last traded price associated with the tradeable object. When the last traded price associated with the tradeable object changes, the wearable trading device may update the indication, via the at least one market indicator, to reflect the relative change in the last traded price.

The market indicators may be included around a circumference of a wristband. The market indicators may be spaced around the circumference of the wristband at relatively different distances from a center of the wristband. The wearable trading device may receive an indication of a centering price associated with the tradeable object at the electronic exchange. The centering price may be a last traded price associated with the tradeable object. The wearable trading device may determine a relative change in the market position of the tradeable object from the centering price and may identify at least one of the market indicators that is located a relative distance from the center of the wristband to reflect the relative change in the market position of the tradeable object from the centering price.

The wearable trading device may indicate, via the at least one market indicator, the relative change in the market position of the tradeable object relative to the centering price. When the last traded price associated with the tradeable object changes, the wearable trading device may update the indication, via the at least one market indicator, to reflect the relative change in the market position of the tradeable object relative to the last traded price.

The wearable trading device may be a wristband or a watch. The market indicators in the wearable trading device may include a light module, a haptic communication module, and/or a temperature module.

The at least one market indicator may include a price indicator that indicates a relative incremental or decremental change in price of the tradeable object. The at least one market indicator may include a volume indicator that indicates a relative quantity of the tradeable object. The market indicators may include sell order fill indicators that indicate a relative price of sell orders that have been filled related to the tradeable object. The market indicators may include buy order fill indicators that indicate a relative price of buy orders that have been filled related to the tradeable object. The market indicators may include working order indicators that indicate a relative price of working orders at the electronic exchange.

The wearable trading device may include a display. The wearable trading device may receive market data and display one or more portions of the market data. The market data may include a last traded price, an order quantity, a net change, an order type, an open profit/loss (P/L), an execution average price, and/or a net position.

The wearable trading device may receive an indication of an order price and an order quantity for a trade order to be submitted to the electronic exchange and send the trade order to the electronic exchange. The wearable trading device may identify a selection of a trade out button and send a trade order to the electronic exchange for a complete fill of a quantity of the tradeable object a user has pending at the electronic exchange. The wearable trading device may determine a price at the electronic exchange that has an available quantity that is at least the quantity of the tradeable object the user has pending at the electronic exchange and send the trade order to the electronic exchange with the determined price.

The embodiments described herein may be implemented by a computing device. For example, the computing device may comprise hardware and software modules for implementing the described embodiments.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### II. EXAMPLE ELECTRONIC TRADING SYSTEM

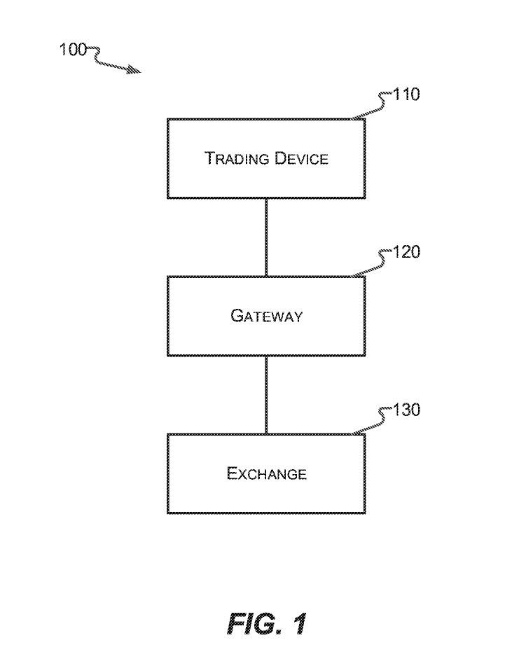

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market refers to the highest available bid price (best bid) and the lowest available ask price (best ask or best offer) in the market for the tradeable object at a particular point in time (since the inside market may vary over time). Market depth refers to quantities available at price levels including the inside market and away from the inside market. Market depth may have “gaps” due to prices with no quantity based on orders in the market.

The price levels associated with the inside market and market depth can be provided as value levels which can encompass prices as well as derived and/or calculated representations of value. For example, value levels may be displayed as net change from an opening price. As another example, value levels may be provided as a value calculated from prices in two other markets. In another example, value levels may include consolidated price levels.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange, a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object; a command to initiate managing orders according to a defined trading strategy; a command to change, modify, or cancel an order; an instruction to an electronic exchange relating to an order; or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET™ provided by Trading Technologies, for example.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. Once an order to buy or sell a tradeable object is received and confirmed by the exchange, the order is considered to be a working order until it is filled or cancelled. If only a portion of the quantity of the order is matched, then the partially filled order remains a working order. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. EXPANDED EXAMPLE ELECTRONIC TRADING SYSTEM

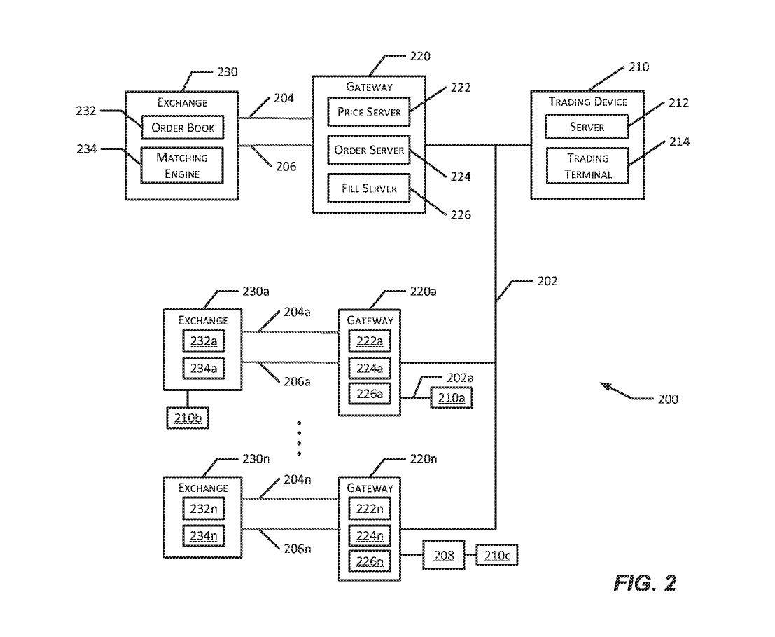

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. EXAMPLE COMPUTING DEVICE

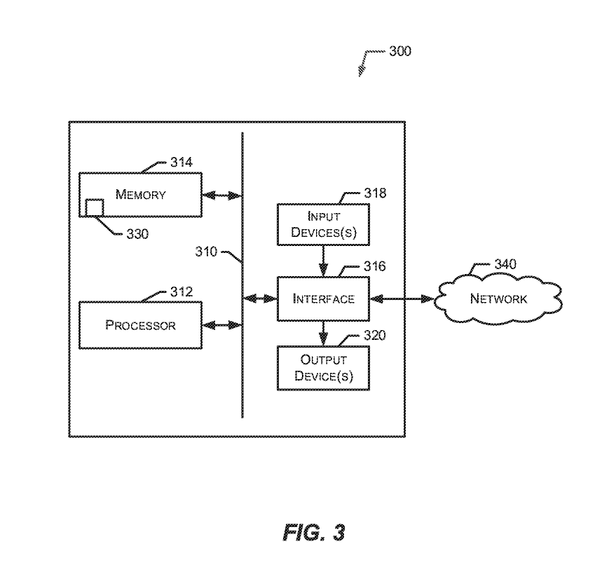

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. WEARABLE TRADING DEVICE

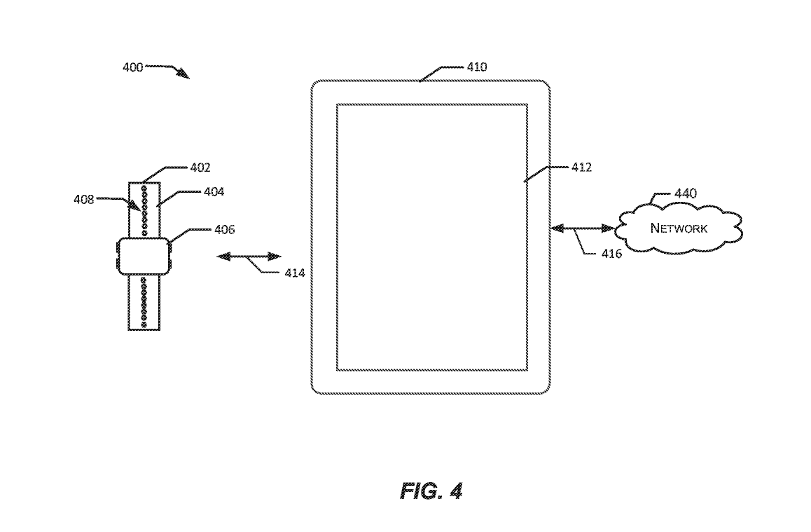

FIG. 4 shows an example system 400 in which a wearable trading device 402 may be implemented for indicating a market position of a tradeable object at an electronic exchange. The wearable trading device 402 may be a computing device capable of indicating changes to a market related to a tradeable object at an electronic exchange. As shown in FIG. 4, the wearable trading device 402 may include a wristband 404. The wearable trading device 402 may also include a display 406. For example, the wearable trading device 402 may be a watch (e.g., an APPLE WATCH® or the like), a FITBIT®, or another wearable device having a wristband 404. The display 406 may be an input device and/or an output device. The display 406 may display the time, applications, and/or other information. The display 406 may also identify user input upon receiving user selections on the display 406. Though the wearable trading device 402 is shown as having a wristband 404, other wearable devices may be implemented as described herein to indicate market data related to a tradeable object at an electronic exchange.

The wearable trading device 402 may include market indicators 408. The market indicators 408 may be light modules, haptic communication modules, and/or temperature modules that may indicate to a user changes to a market related to a tradeable object (e.g., which way the market is moving). The wearable trading device 402 may activate different market indicators 408 to identify different changes to the market. Different types of market indicators 408 may be included in the wearable trading device 402. For example, the wearable trading device 402 may include light modules on the outer surface of the wristband 404 for user visibility and haptic communication modules or temperature modules on the inner surface for the user to touch. Light modules may include light emitting diodes (LEDs) or other light sources. Haptic communication modules may include an actuator or other haptic module capable of applying pressure or vibrations that may be perceived by a user. The temperature modules may include heat sinks (e.g., alloy-based heat sinks) capable of adjusting the intensity and duration of thermal pulses received by the heat sinks. The light modules, haptic communication modules, and/or temperature modules may be controlled by an electronic circuit capable of controlling the electrical load provided to the modules.

As shown in FIG. 4, the market indicators 408 may be located around a circumference of the wristband 404. The use of the circumference of the wristband 404 may enable more area for displaying market data than using the display 406. The market indicators 408 may be spaced in series around the circumference of the wristband 404 at relatively different distances from a reference point on the wristband 404, such as the center of the wristband 404. The market indicators 408 may be activated to indicate market movement. The wristband 404 may allow for price information typically displayed as part of a value axis such as a price ladder to wrap around the user's wrist and/or indicate portions of the price information on the wristband 404.

As the market moves, the market indicators 408 may be activated to indicate where the market trades relative to the reference point. For example, the user may store a last traded price of a tradeable object on the wearable trading device when the last traded price is 2001.50. The stored last traded price may be referred to as a centering price. If the market trades lower than the centering price, the wristband 404 may activate the market indicators 408 along the bottom side of the wristband 404 and away from the center of the wristband 404. As the market moves away from the centering price, the market indicators 408 may be activated further away from the reference point. As the price moves back up and through the centering price, the wristband 404 may activate the market indicators 408 along the top side of the wristband 404 and away from the center of the wristband 404.

The wearable trading device 402 may receive market data and/or other information from a computing device 410 and/or a network 440 via wireless communication signals 414 and/or wireless communication signals 416. The wearable trading device 402 may receive the market data and determine the market indicators 408 to activate based on the market data. The wearable trading device 402 may calculate changes to the market data from previously received market data for identifying the changes. The wearable trading device 402 may display the market data, or portions thereof, on the display 406. The market data may include order prices and/or quantities, such as working order prices and/or quantities, prices and/or quantities of orders that have been filled, a last traded price, an execution average price, and/or other information related to order prices and/or quantities. The market data may include other information, such as a net position of the user, an order type, an open P/L, and/or other information.

The wearable trading device 402 may receive portions of the market data and/or other information from the computing device 410 via the wireless communication signals 414 for indicating to a user different market information related to a tradeable object. For example, the computing device 410 may receive the market data via the wireless communication signals 416 from a network 440. The computing device 410 may determine the market indicators 408 to activate and/or the market data to be displayed on the display 406 of the wearable trading device 402 based on the market data and may identify the market indicators 408 to activate and/or the market data to be displayed to the wearable trading device 402 via the wireless communication signals 414. The computing device 410 may perform processing based on the market data to conserve processing power (e.g., battery power) at the wearable trading device 402 and/or enable less information to be transmitted over the wireless communication signals 414 (e.g., short-range wireless communication signals).

The wireless communication signals 414 and the wireless communication signals 416 may be transmitted over different wireless communication protocols. For example, the wireless communication signals 414 may be communicated over a short-range wireless communication protocol (e.g., BLUETOOTH®, near field communications (NFCs), and/or another short-range wireless communication protocol), and the wireless communication signals 416 may be communicated over another wireless communication protocol (e.g., Wi-Fi, cellular, etc.). The wireless communication signals 414 and the wireless communication signals 416 may be transmitted over the same wireless communication protocol. For example, the wireless communication signals 414 and the wireless communication signals 416 may be Wi-Fi communication signals communicated over a Wi-Fi network.

The wearable trading device 402 may include an interface, such as the interface 316 shown in FIG. 3 that comprises one or more transceivers that are capable of communicating on one or more protocols. The interface may be included in the wristband 404 and/or the display 406. The wristband 404 and/or the display 406 may include one or more other components of the computing device 300 illustrated in FIG. 3. For example, the components may be included in the wristband 404, such that the wristband 404 may operate independent of the display 406, and vice versa. In another example, the components may be distributed throughout the wristband 404 and the display 406. The wristband 404 may be activated when connected to the display 406 (e.g., via an electrical connection).

The computing device 410 may be a wireless computing device, such as a wireless phone (e.g., cellular phone), a tablet, a laptop computer, or other wireless computing device. The computing device 410 may include a display 412 that may display the market data, or portions thereof, received over the network 440 and/or from the wearable trading device 402. The display 412 may be an input device and/or an output device. The display 412 may display applications and/or other information. The display 412 may also identify user input upon receiving user selections on the display 406. The computing device 410 may enable user selection of different types of market data, and/or changes to market data, to be identified on the wearable trading device 402. The computing device 410 may be a trading device, as described herein.

The user may select a button (e.g., soft button displayed on the display 412 or hard button) on the computing device 410 to enable remote monitoring of the market on the wearable trading device 402. Similarly, the user may select a button (e.g., soft button displayed on the display 412 or hard button) on the computing device 410 and/or the wearable trading device 402 to disable remote monitoring of the market on the wearable trading device 402. The user may select the configuration (e.g., type, location, etc.) of the market information to be identified on the wearable trading device 402 at the computing device 410 and the configuration may be communicated to the wearable trading device 402 for being implemented. The user may also, or alternatively, select the configuration (e.g., type, location, etc.) of the market information at the wearable trading device 402 and the configuration may be implemented.

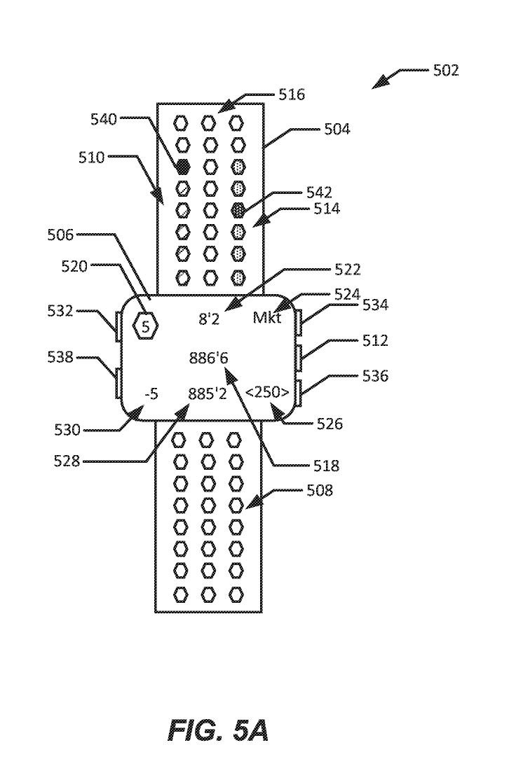

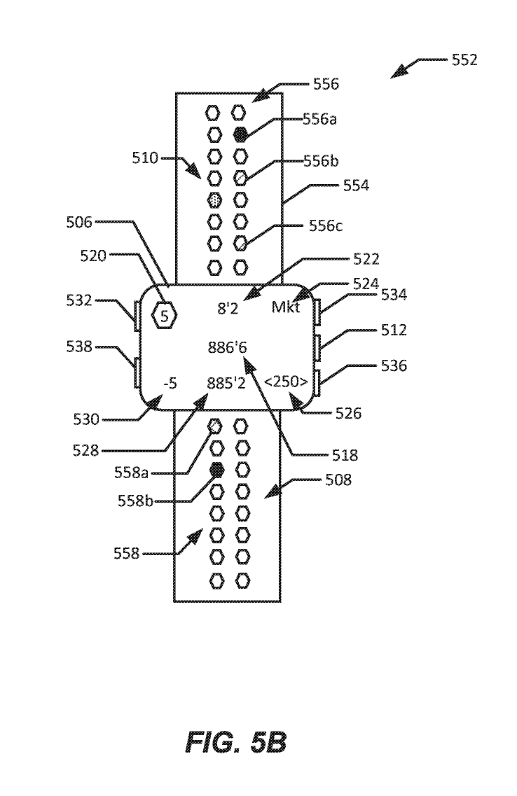

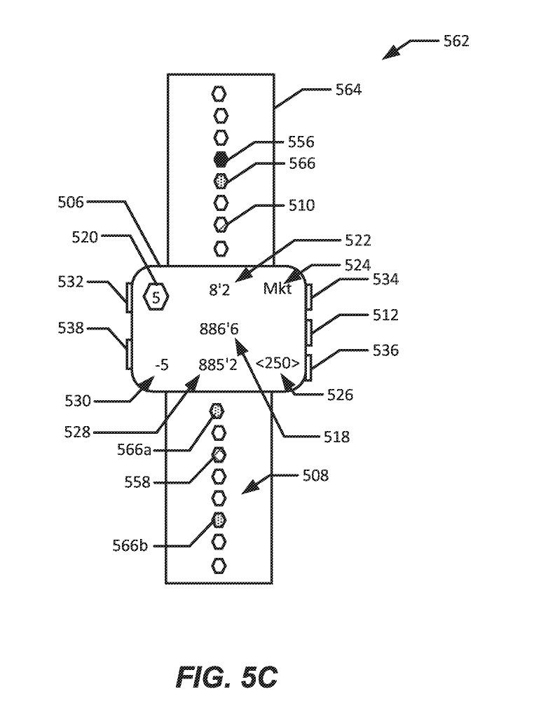

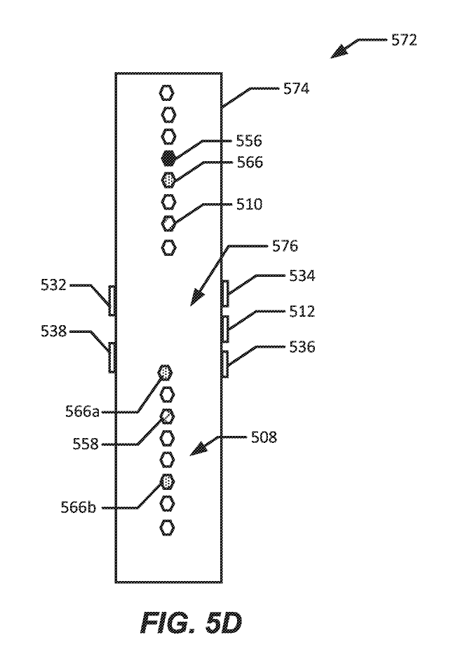

FIGS. 5A-5D show examples of wearable trading devices for indicating a market position of a tradeable object at an electronic exchange. As shown in FIG. 5A, a wearable trading device 502 may include market indicators 508. The market indicators 508 may be included in the wearable trading device 502 at relatively different distances to identify relative changes in the market. For example, the market indicators 508 may be included in relatively different distances around the circumference of the wristband 504 of the wearable trading device 502.

The market indicators 508 that are relatively further from the center of the wristband 504 may be activated (e.g., light module turned on, haptic communication module causing a vibration and/or applying pressure to a user, temperature modules warmed or cooled, etc.) to identify a relatively greater change in the market. The market indicators 508 that are relatively closer to the center of the wristband 504 may be activated (e.g., light module turned on, haptic communication module causing a vibration and/or applying pressure to a user, temperature modules warmed or cooled, etc.) to identify a relatively smaller change in the market.

The market indicators 508 may identify changes in the market that correspond to one or more identified tradeable objects. The tradeable objects may be identified on the display 506 of the wearable trading device 502 by selection of a button on the wearable trading device 502 and/or selection on another computing device with which the wearable trading device may be in communication. Though the examples herein may be described with reference to a single tradeable object, similar information may be identified at the wearable trading device for multiple tradeable objects.

The market indicators 508 may be included in the wristband 504 in different rows that each correspond to an incremental or decremental change to the market for the tradeable object at an electronic exchange. Each row of market indicators 508 may identify the same amount of incremental or decremental change (e.g., 0.25 for each row, 0.5 for each row, etc.) in the market. Each row of market indicators 508 may identify an increasing amount of incremental change or a decreasing amount of decremental change (e.g., 0.25 for the first row, 0.5 for the second row, etc.) in the market. Though the center of the wristband 504 may be the point of reference from which the changes in the market may be identified, the changes in the market may be identified from other points of reference, such as an end of the wristband 504, the display 506, or another defined point of reference on the wristband 504. The wearable trading device 502 may update the activation of the price indicators 510 (e.g., turn on light modules, vibrate haptic communication modules, apply pressure via haptic communication modules, warm or cool temperature modules, etc.) that identify the relative changes in the market data from the market data received from the electronic exchange.

Different portions of the market indicators 508 may identify changes to different types of market data. For example, the market indicators 508 may include price indicators 510 for indicating a price of a tradeable object, volume indicators 514 for indicating a quantity of the tradeable object that is available, and/or other indicators 516 that may indicate changes to different types of market data. Each of the different types of market indicators 510, 514, 516 may be displayed in a different column or other portion of the wristband 504.

In certain embodiments, the larger the degree of change detected in the market may trigger a more intense activation on the market indicators 508. For example, the market indicators 508 may identify a small relative price change and trigger a relatively weak activation on the market indicators 508. Similarly, in certain embodiments, a large relative quantity for a trade may be detected resulting an intense activation on the market indicators 508. Depending upon the detected change and the magnitude of the change relative to a previous value or threshold, a user may be alerted by the activation of a light module at a brighter light level, vibrating a haptic communication module more intensely or more times, applying a greater amount of pressure via the haptic communication module, and/or heating or cooling a temperature module to a greater or lesser temperature.

The price indicators 510 may indicate a relative change in price from a last traded price 518 and/or a centering price of an identified tradeable object at the electronic exchange. The last traded price 518 may be displayed on the display 506 of the wearable trading device 502. The last traded price 508 may be the last price at which the tradeable object was matched at the exchange at a given time or the last price at which the tradeable object was matched prior to being stored at the wearable trading device 502. The last traded price and the centering price may be the same price at a given time. For example, the user may select a button 512 on the wearable trading device 502 to identify and store the last traded price 518 of the tradeable object as the centering price around which the price indicators 510 may be centered. The button 512 may be activated (e.g., pressed) to recenter the centering price at the last traded price when the last traded price has changed. The button 512 may be configured to perform another function upon activation, and may be activated (e.g., pressed) multiple times to recenter the centering price at the last traded price when the last traded price has changed. A soft button (e.g., a icon or other graphical indictor) on the display 506, or the display 506 itself, may be activated (e.g., pressed) to recenter the centering price at the last traded price.

The price indicators 510 may indicate relative incremental and/or decremental changes in price from the centering price of the identified tradeable object. The wearable trading device 502 may activate the price indicators 510 (e.g., turn on light modules, vibrate haptic communication modules, apply pressure via haptic communication modules, warm or cool temperature modules, etc.) that identify the relative change in the last traded price 518 from the stored centering price as the last traded price 518 is updated from the market data received from the electronic exchange. For example, if the centering price is stored at the wearable trading device 502 at a price of 886 and the last traded price increases to 886′6, the sixth price indicator 510 (identified by the reference indicator 540) above the display 506 may be activated (e.g., when each price indicator 510 represents one tick).

When the last traded price 518 of the tradeable object changes, the price indicators 510 may be updated to reflect the relative change in price from the centering price. For example, if the centering price is stored at the wearable trading device 502 at the price of 886 and the last traded price decreases from 886′6 to 886′5, the fifth price indicator 510 above the display 506 may be activated (e.g., when each price indicator 510 represents one tick). The wearable trading device 502 may activate each of the price indicators 510 above the display 506 to identify the prices at which trade orders have been matched for the tradeable object at the electronic exchange (e.g., since storing the centering price, over a period of time, such as a day, etc.). Though the price indicators 510 are activated above the display 506, if the last traded price falls below the centering price, the price indicators 510 below the display 506 may be similarly activated to identify the relative change in price.

The last traded price indicator 540 may be the price indicator 510 that is activated to identify the last traded price may be distinguished from the other price indicators 510 that may be activated to represent previously traded on prices (e.g., since storing the centering price, over a period of time, such as a day, etc.). As shown in FIG. 5A, the last traded price indicator 540 may identify the last traded price 518 of 886′6, while the price indicators 510 below the last traded price indicator 540 may remain activated as previously being traded on, but may be distinguished from the last traded price indicator 540. When the price indicators 510 are light modules, the light module identifying the last traded price 518 may be activated with a brighter or dimmer light, a different color or shade of light, displayed in a different pattern (e.g., flashing or flashing in a different pattern), and/or otherwise differentiate the light module identifying the last traded price 518. When the price indicators 510 are haptic communication modules, the haptic communication module identifying the last traded price 518 may be activated to vibrate more or less intensely, vibrate in a different pattern, apply more or less pressure to the user, and/or otherwise differentiate the haptic communication module identifying the last traded price 518. When the price indicators 510 are temperature modules, the temperature module identifying the last traded price 518 may be activated at a different temperature (e.g., higher or lower) and/or otherwise differentiate the temperature module identifying the last traded price 518.

The centering price may be reset after a predefined period of time (e.g., a day, an hour, etc.) or upon an indication from a user. For example, the user may select the button 512 on the wearable trading device 502 and/or the display 506 to reset the centering price. The centering price may be stored as the last traded price at the time the centering price is reset.

The market indicators 508 in the trading band 504 may include volume indicators 514 that may identify changes in volume (e.g., quantity) for a tradeable object at an electronic exchange. The volume indicators 514 may correspond to the price indicators 510, such that the volume indicators 514 identify the volume at price (VAP) for each price indicator 510. A volume indicator 514 may be activated upon activation of a corresponding price indicator 510 (e.g., in the same row) that identifies a trade order that has been matched at the electronic exchange. The volume indicators 514 may reflect the relative volume of the trade orders that have been matched at the corresponding prices identified by the price indicators 510.

As shown in FIG. 5A, the volume indicators 514 that represent the trade orders having a greater volume may be distinguished from the volume indicators 514 that represent the trade orders having a lesser volume. The volume indicators 514 may each be activated to identify different relative volumes, different ranges of volumes, and/or the greatest relative volume. When the volume indicators 514 are light modules, the volume indicator 542 identifying the greatest relative volume may be activated with a brighter or dimmer light, a different color or shade of light, in a different pattern (e.g., flashing or flashing in a different pattern), and/or otherwise differentiate the light module identifying the greatest relative volume. The light modules identifying lesser relative volumes or lesser relative ranges of volumes may be activated with a brighter or dimmer light, a different color or shade of light, in a different pattern (e.g., flashing or flashing in a different pattern), and/or otherwise differentiate the light module identifying the lesser relative volumes or lesser relative ranges of volumes. When the volume indicators 514 are haptic communication modules, the volume indicator 542 identifying the greatest relative volume may be activated to vibrate more or less intensely, vibrate in a different pattern, apply more or less pressure to the user, and/or otherwise differentiate the haptic communication module identifying the greatest relative volume. The haptic communication modules identifying lesser relative volumes or lesser relative ranges of volumes may be activated to vibrate more or less intensely, vibrate in a different pattern, apply more or less pressure to the user, and/or otherwise differentiate the haptic communication module identifying the lesser relative volumes or lesser relative ranges of volumes. When the volume indicators 514 are temperature modules, the volume indicator 542 identifying the greatest relative volume may be activated to a different temperature (e.g., higher or lower) and/or otherwise differentiate the temperature module identifying the greatest relative volume. The temperature modules identifying lesser relative volumes or lesser relative ranges of volumes may be activated to a different temperature (e.g., higher or lower) and/or otherwise differentiate the temperature module identifying the lesser relative volumes or lesser relative ranges of volumes. Though the volume indicators 514 are activated above the display 506, the volume indicators 514 may be activated below the display 506. Additionally, though the volume indicators 514 are shown in FIG. 5A as corresponding to the price indicators 510, the volume indicators 514 may correspond to any other indicators (e.g., sell order fill indicators, buy order fill indicators, working order indicators, etc.) that identify price information to identify a corresponding volume of the trade order having the identified price information.

The market indicators 508 in the trading band 504 may include indicators 516 that may identify other changes or conditions in the market for a tradeable object at an electronic exchange. For example, the indicators 516 may be utilized to identify one or more thresholds or triggers established by the user. For example, the thresholds or triggers may indicate when a predetermined trading action is to be undertaken by an algorithm, or when a price or volume of interest has been reached. In certain embodiments, the indicators 516 may be technical indicators defined and provided by, for example, the computing device 410. The technical indicators defined at the example computing device 410 may represent changing and/or calculated variables provided to the trading band 504 based on the rate of update or change in the value to be displayed. For example, indicators 516 that are calculated in real time may be continuously provided while indicators 516 that are calculated periodically may be provided only when a change is detected.

The display 506 may generate one or more displays of market information. For example, the display may include the last traded price 518, an order quantity 520, a net change 522, an order type 524, an open profit/loss (P/L) 526, an execution average price 528, a net position 530, and/or other market information. The order quantity 520 may be the quantity of pending orders of the tradeable object in the order book at the electronic exchange. The net position 530 may reflect the net position of the user in the market based on the order quantity 520. The net change 522 may be the net change of the last traded price of the tradeable object from the closing price of the tradeable object the previous day. In another embodiment, the net change 522 may be the change calculated with respect to previous update. The order type 524 may identify the order type of the order pending at the order book of the electronic exchange. The order type may be a market order, an aggressive order, or a passive order, for example. The open P/L 526 may identify a current position with regard to P/L.

The user may submit trade orders via the wearable trading device 502. The user may adjust the buy order quantity by selecting a buy button 532. The user may adjust the sell order quantity by selecting a sell button 534. The quantities may be adjusted by selecting the buy button 532 or the sell button 534 a number of times. Each selection of the buttons 532, 534 may correspond to a tick, for example. The buttons 532, 534 may also, or alternatively, generate a display on the display 506 that enables the user to enter the buy order quantity or the sell order quantity. After the buy order quantity or the sell order quantity has been selected, the wearable trading device 502 may submit a trade order for a quantity of the tradeable object to the electronic exchange. The trade order may be submitted at the last traded price 518 or at another price that may be selected by the user (e.g., on the display 506). The trade order may be submitted from the wearable trading device 502 or the parameters of the trade order may be sent to another computing device from the wearable trading device 502 for being submitted.

The wearable trading device 502 may include a trade out button 538. Selection of the trade out button 538 may be recognized by the wearable trading device 502 for placing an order for a complete fill for the tradeable object or objects a user has pending at the electronic exchange, such that the user may exit the market. For example, the user may select the trade out button 538 to trigger transmission of a trade order for a complete fill of the tradeable objects pending at the electronic exchange. The trade order may be submitted to the electronic exchange by the wearable trading device 502 or the wearable trading device 502 may send an indication to another computing device to submit the trade order. The trade order may be submitted at a price that enables the user to match the currently pending trade orders and exit the exchange upon performance of a single command. The price may have a corresponding quantity at the exchange that is greater than a predefined threshold above the currently pending trade orders to provide a greater opportunity for the trade order to receive a match after being submitted to the electronic exchange.

The wearable trading device 502 may include a tools button 536. The tools button 536 may be selected to display trading tools on the display 506. The trading tools may be used to display tradeable objects and/or market data related to the tradeable objects. Different trading tools may be used to display different market data for the tradeable objects. The trading tools may be applications (e.g., trading applications). For example, the trading tools may be trading applications such as ADL®, AUTOSPREADER®, and/or AUTOTRADER™, provided by Trading Technologies.

The trading tools may include a market grid tool, a time and sales tool, an order window tool, and/or a chart tool. The market grid tool may display real-time market data for tradeable objects. The time and sales tool may identify records of sales information for tradeable objects. For example, the records in the time and sales tool may identify a time and a sale of selected tradeable objects for a defined period of time. The trading tool may display real-time market data for selected tradeable objects and may allow a user to submit trade orders to an exchange. For example, a trading tool may be a tool such as MD TRADER® provided by Trading Technologies. In certain embodiments, an MD TRADER® type trading tool may be a tabbed tool configured to displayed the components for a spread, a trading algorithm and/or multiple tradeable objects of interest. The chart tool may display a graphical representation or chart identifying the market data for a selected tradeable object over a defined period of time. The chart tool may identify trends in the market data for the identified tradeable objects over the defined period of time. The order window tool may allow a user to enter one or more order parameters for a trade order. Each of the tools may have different parameters of market data that may be retrieved and displayed to a user upon selection.

FIG. 5B shows another example of a wearable trading device 552 for indicating a market position of a tradeable object at an electronic exchange. The wearable trading device 552 has two columns of market indicators 508, though any number of market indicators may be implemented to identify similar information on different portions of the wearable trading device 552. As shown in FIG. 5B, the wearable trading device 552 may include a wristband 554 that has a dual column configuration of market indicators 508. The wristband 554 may include sell order fill indicators 556. The sell order fill indicators 556 may indicate relative price of sell orders that have been filled from the centering price of the identified tradeable object. The wearable trading device 552 may activate the sell order fill indicators 556 (e.g., turn on light modules, vibrate haptic communication modules, apply pressure via haptic communication modules, warm or cool temperature modules, etc.) to identify the relative price of sell orders that have been filled from the centering price of the identified tradeable object.

The sell order fill indicators 556a, 556b are activated to identify the price of sell orders that have been filled relative to the centering price. The sell order fill indicators 556a, 556b may be activated to identify the price of sell orders identified over a period of time (e.g., over a day, from last recentering of price at wearable trading device, etc.). The sell order fill indicator 556a may be activated to identify the highest traded price of sell orders that have been filled over the period of time (e.g., over a day, from last recentering of price at wearable trading device, etc.).

The sell order fill indicator 556a may be activated to distinguish the highest traded price of sell orders that have been filled from the price of the other sell orders that have been filled (e.g., since storing the centering price, over a period of time, such as a day, etc.). When the sell order fill indicators 556 are light modules, the sell order fill indicator 556a identifying the highest traded price of sell orders that have been filled may be activated with a brighter or dimmer light, a different color or shade of light, displayed in a different pattern (e.g., flashing or flashing in a different pattern), and/or otherwise differentiate the sell order fill indicator 556a identifying the highest traded price of sell orders that have been filled. When the sell order fill indicators 556 are haptic communication modules, the sell order fill indicator 556a identifying the highest traded price of sell orders that have been filled may be activated to vibrate more or less intensely, vibrate in a different pattern, apply more or less pressure to the user, and/or otherwise differentiate the sell order fill indicator 556a identifying the highest traded price of sell orders that have been filled. When the sell order fill indicators 556 are temperature modules, the sell order fill indicator 556a identifying the highest traded price of sell orders that have been filled may be activated at a different temperature (e.g., higher or lower) and/or otherwise differentiate the sell order fill indicator 556a identifying the highest traded price of sell orders that have been filled.

The wristband 554 may include buy order fill indicators 558. The buy order fill indicators 558 may indicate the relative price of buy orders that have been filled from the centering price of the identified tradeable object. The wearable trading device 552 may activate the buy order fill indicators 558 (e.g., turn on light modules, vibrate haptic communication modules, apply pressure via haptic communication modules, warm or cool temperature modules, etc.) to identify the relative price of buy orders that have been filled from the centering price of the identified tradeable object.

The buy order fill indicators 558a, 558b are activated to identify the price of buy orders that have been filled relative to the centering price. The buy order fill indicators 558a, 558b may be activated to identify the price of buy orders that have been filled over a period of time (e.g., over a day, from last recentering of price at wearable trading device, etc.). The buy order fill indicator 558b may be activated to identify the lowest traded price of buy orders that have been filled over the period of time (e.g., over a day, from last recentering of price at wearable trading device, etc.).

The buy order fill indicator 558b may be activated to distinguish the lowest traded price of buy orders that have been filled from the price of the other buy orders that have been filled (e.g., since storing the centering price, over a period of time, such as a day, etc.). When the buy order fill indicators 558 are light modules, the buy order fill indicator 558b identifying the lowest traded price of buy orders that have been filled may be activated with a brighter or dimmer light, a different color or shade of light, displayed in a different pattern (e.g., flashing or flashing in a different pattern), and/or otherwise differentiate the buy order fill indicator 558b identifying the lowest traded price of the buy orders that have been filled. When the buy order fill indicators 558 are haptic communication modules, the buy order fill indicator 558b identifying the lowest traded price of buy orders that have been filled may be activated to vibrate more or less intensely, vibrate in a different pattern, apply more or less pressure to the user, and/or otherwise differentiate the buy order fill indicator 558b identifying the lowest traded price of buy orders that have been filled. When the buy order fill indicators 558 are temperature modules, the buy order fill indicator 558b identifying the lowest traded price of buy orders that have been filled may be activated at a different temperature (e.g., higher or lower) and/or otherwise differentiate the buy order fill indicator 558b identifying the lowest traded price of buy orders that have been filled.

The wristband 554 may include price indicator 510 which represents the last traded price (LTP). The last traded price represented by the price indicators 510, the buy order fill indicators 558, and/or the sell order fill indicators 556 may be activated such that each is distinguished from one another. The last traded price represented by the price indicators 510, the buy order fill indicators 558, and/or the sell order fill indicators 556 may be different types of modules (e.g., light modules, haptic communication modules, temperature modules, etc.), or the same modules may be activated differently as described herein, to differentiate the different types of information communicated from each indicator.

FIG. 5C shows another example of a wearable trading device 562 for indicating a market position of a tradeable object at an electronic exchange. The wearable trading device 562 has one column of market indicators 508, though any number of market indicators may be implemented to identify similar information on different portions of the wearable trading device 562. As shown in FIG. 5C, the wearable trading device 562 may include a wristband 564 that has a configuration of market indicators 508. The market indicators 508 may identify a relative price of sell order fills, such as with sell order fill indicator 556. The sell order fill indicator 556 may be activated to identify the highest traded price of sell orders that have been filled over a period of time (e.g., over a day, from last recentering of price at wearable trading device, etc.). The market indicators 508 may identify a relative price of buy order fills, such as with buy order fill indicator 558. The buy order fill indicator 558 may be activated to identify the lowest traded price of buy orders that have been filled over a period of time (e.g., over a day, from last recentering of price at wearable trading device, etc.). The market indicators 508 may include a price indicator 510 that represents the last traded price that may be activated to identify a relative price at which the last traded price was traded.

The market indicators 508 may identify a relative price of working orders at an electronic exchange, such as with working order indicators 566, 566a, 566b. The working order indicators 566, 566a, 566b may be activated to identify the price of the working orders relative to the centering price or the last traded price (LTP).

The different types of market data may be identified by activating the market indicators 508 differently to distinguish the types of market data being identified from one another. For example, the sell order fill indicator 556, the buy order fill indicator 558, the price indicator 510, and/or the working order indicators 566, 566a, 566b may be activated differently for distinction. When the market indicators are light modules, the market indicators 508 that are activated to identify the relative price of different market data may be activated with a brighter or dimmer light, a different color or shade of light, displayed in a different pattern (e.g., flashing or flashing in a different pattern), and/or otherwise differentiate the light modules identifying the different types of market data. When market indicators 508 are haptic communication modules, the market indicators 508 that are activated to identify the relative price of different market data may be activated to vibrate more or less intensely, vibrate in a different pattern, apply more or less pressure to the user, and/or otherwise differentiate the haptic communication modules identifying the different types of market data. When the market indicators 508 are temperature modules, the market indicators 508 that are activated to identify the relative price of different market data may be activated at a different temperature (e.g., higher or lower) and/or otherwise differentiate the temperature modules identifying the different types of market data.

Though the different types of market data may be identified with a different activation of a similar type of module (e.g., light modules, haptic communication modules, temperature modules, etc.), different types of market data may be identified using different types of modules altogether. For example, the price indicator 510 that represents the last traded price may be identified by activating a light module, while the order fill indicators 556, 558 may be identified by activating a haptic communication module, or vice versa. Though different market indicators 508 are shown to display different types of market data, a single market indicator 508 may be used to identify different types of market data.

FIG. 5D shows another example of a wearable trading device 572 for indicating a market position of a tradeable object at an electronic exchange. The wearable trading device 572 includes a wristband 574 without a display. The wristband includes market indicators 508 that identify similar information to the wearable trading device 562 shown in FIG. 5D, though any configuration of market indicators 508 may be implemented.

The wearable trading device 572 may include a space 576 or other indicator that may be representative of the centering price or other point of reference on the wearable trading device 572. The wearable trading device 572 may include one or more buttons, such as buttons 512, 532, 534, 536, and/or 538. The buttons may be programmed for the same functionality as described herein, or other functionality, as the wearable trading device 572 may not include a display for displaying information that may be triggered by selection of one or more of the buttons.

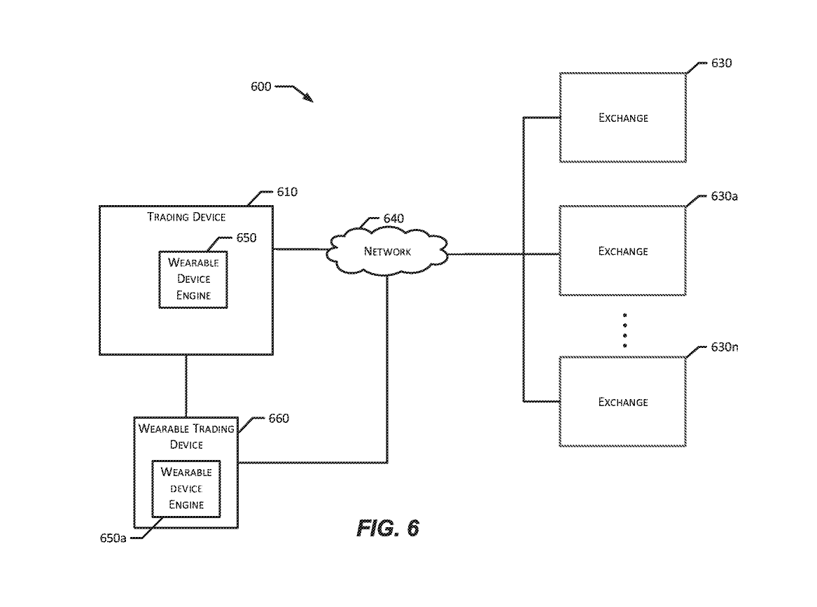

FIG. 6 illustrates a block diagram of an example system 600 that may be used to implement a wearable trading device 660. The system 600 may include a trading device 610 that may receive market data from one or more exchanges, such as exchange 630 and/or exchanges 630a to 630n. The market data may correspond to one or more tradeable objects at each market. The trading device 610 may communicate with the exchanges directly or through a network 640. The trading device 610 may be a trading server and/or a trading terminal.

The system 600 may include the wearable trading device 660. The wearable trading device 660 may receive market data from one or more exchanges, such as exchange 630 and/or exchanges 630a to 630n. The market data, or portions thereof, may be received from the trading device 610. The wearable trading device 660 may also, or alternatively, communicate with the exchanges directly or through the network 640.

The functionality described herein may be performed on the trading device 610, the wearable trading device 660, or may be distributed across the trading device 610 and the wearable trading device 660. For example, the trading device 610 may include a wearable device engine 650 and/or the wearable trading device 660 may include a wearable device engine 650a that may be used to process information at each of the devices to perform as described herein. The wearable device engine 650 may communicate market data and/or other information for indicating to a user different market information related to a tradeable object. For example, the wearable trading device engine 650 may identify the market data to be communicated to the wearable device engine 650a to enable the wearable trading device 660 to update the market indicators and/or the display of information at the wearable trading device 660. The wearable device engine 650 may also, or alternatively, process the market data and communicate to the wearable device engine 650a the market indicators to be activated and/or the information to be displayed to the user.

As described herein, the wearable trading device 660 may also, or alternatively, receive market data from the exchanges directly or through the network 640. The wearable device engine 650a may identify the market data for being identified on the wearable trading device 660 and may activate the market indicators and/or display the market data to a user.

The trading device 610 may display market data that may or may not be displayed on the wearable trading device 660. For example, the wearable trading device engine 650 may generate a display of market data that may be relatively indicated on the wearable trading device 660 (e.g., via the market indicators). The wearable device engine 650 may display more detailed market data that may be displayed in short form on the wearable trading device 660 (e.g., via the wearable device engine 650a) or may not be displayed on the wearable trading device 660. The processing and display of other market data at the trading device 610 may enable more efficient network communications to the wearable trading device 660 and/or conserve battery power at the wearable trading device 660, which may be a smaller device with a smaller battery.

The wearable device engines 650, 650a may be executed as software and/or hardware. For example, the wearable device engine 650 may be a software module included in a trading application executed by a processor from memory at the trading device 610, or an independent hardware module. The wearable device engine 650a may be a software module included in a trading application executed by a processor from memory at the wearable trading device 660, or an independent hardware module.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A wearable trading device for indicating a market position of a tradeable object at an electronic exchange, the wearable trading device comprising:
a wristband comprising a plurality of market indicators located around a circumference of the wristband, wherein the plurality of market indicators are spaced around the circumference of the wristband at relatively different distances from a center of the wristband; and
a processor configured to:
receive an indication of a centering price associated with the tradeable object at the electronic exchange, wherein the centering price comprises a last traded price associated with the tradeable object;
determine a relative change in the market position of the tradeable object from the centering price;
identify at least one of the plurality of market indicators that is located a relative distance from the center of the wristband to reflect the relative change in the market position of the tradeable object from the centering price;
indicate, via the at least one of the plurality of market indicators, the relative change in the market position of the tradeable object relative to the centering price; and
when the last traded price associated with the tradeable object changes, update the indication, via the at least one of the plurality of market indicators, to reflect the relative change in the market position of the tradeable object relative to the last traded price.

2. The wearable trading device of claim 1, wherein the plurality of market indicators comprise at least one of a light module, a haptic communication module, or a temperature module.

3. The wearable trading device of claim 1, wherein the wearable trading device comprises a watch.

4. The wearable trading device of claim 1, wherein the at least one of the plurality of market indicators comprise a price indicator that indicates a relative incremental or decremental change in price from the centering price of the tradeable object.

5. The wearable trading device of claim 4, wherein the at least one of the plurality of market indicators comprise a volume indicator that indicates a relative quantity of the tradeable object.

6. The wearable trading device of claim 1, wherein the plurality of market indicators comprise sell order fill indicators that indicate a relative price of sell orders that have been filled from the centering price of the tradeable object.

7. The wearable trading device of claim 1, wherein the plurality of market indicators comprise buy order fill indicators that indicate a relative price of buy orders that have been filled from the centering price of the tradeable object.

8. The wearable trading device of claim 1, wherein the plurality of market indicators comprise working order indicators that indicate a relative price of working orders at the electronic exchange.

9. The wearable trading device of claim 1, further comprising:
a display, and
wherein the processor is configured to:
receive market data, and
display, via the display, at least one portion of the market data, wherein the at least one portion of the market data comprises at least one of a last traded price, an order quantity, a net change, an order type, an open profit/loss (P/L), an execution average price, or a net position.

10. The wearable trading device of claim 1, wherein the processor is configured to:
receive an indication of an order price and an order quantity for a trade order to be submitted to the electronic exchange, and
send the trade order to the electronic exchange.

11. The wearable trading device of claim 1, wherein the processor is configured to:
identify a selection of a trade out button, and
send a trade order to the electronic exchange for a complete fill of a quantity of the tradeable object a user has pending at the electronic exchange.

12. The wearable trading device of claim 11, wherein the processor is configured to:
determine a price at the electronic exchange that has an available quantity that is at least the quantity of the tradeable object the user has pending at the electronic exchange, and
send the trade order to the electronic exchange with the determined price.

13. A wearable trading device for indicating a market position of a tradeable object at an electronic exchange, the wearable trading device comprising:
a plurality of market indicators configured to indicate relative changes in the market position of the tradeable object at the electronic exchange; and
a processor configured to:
receive an indication of a last traded price associated with the tradeable object;
determine a relative change in the last traded price associated with the tradeable object;
identify at least one of the plurality of market indicators that reflects the relative change in the last traded price associated with the tradeable object;
indicate, via the at least one of the plurality of market indicators, the relative change in the last traded price associated with the tradeable object; and
when the last traded price associated with the tradeable object changes, update the indication, via the at least one of the plurality of market indicators, to reflect the relative change in the last traded price.

14. The wearable trading device of claim 13, wherein the plurality of market indicators comprise at least one of a light module, a haptic communication module, or a temperature module.

15. The wearable trading device of claim 13, wherein the wearable trading device comprises a wristband or a watch.

16. The wearable trading device of claim 13, wherein the at least one of the plurality of market indicators comprise a price indicator that indicates a relative incremental or decremental change in price of the tradeable object.

17. The wearable trading device of claim 16, wherein the at least one of the plurality of market indicators comprise a volume indicator that indicates a relative quantity of the tradeable object.

18. The wearable trading device of claim 13, wherein the plurality of market indicators comprise sell order fill indicators that indicate a relative price of sell orders that have been filled related to the tradeable object.

19. The wearable trading device of claim 13, wherein the plurality of market indicators comprise buy order fill indicators that indicate a relative price of buy orders that have been filled related to the tradeable object.

20. The wearable trading device of claim 13, wherein the plurality of market indicators comprise working order indicators that indicate a relative price of working orders at the electronic exchange.
